(19) United States
(12) Patent Application Publication
(10) Pub. No.: US 2013/0277942 A1
(43) Pub. Date: Oct. 24, 2013

(54) ARTICULATION AND OSCILLATION JOINT FOR VEHICLE

(71) Applicants: Jacob CHRISTENSEN, Grand Junction, MI (US); Dave SHOEMAKER, Coloma, MI (US)

(72) Inventors: Jacob CHRISTENSEN, Grand Junction, MI (US); Dave SHOEMAKER, Coloma, MI (US)

(21) Appl. No.: 13/864,536

(22) Filed: Apr. 17, 2013

Related U.S. Application Data
(60) Provisional application No. 61/625,962, filed on Apr. 18, 2012.

(51) Int. Cl. B62D 53/02

(52) U.S. Cl. CPC B62D 53/02
USPC 280/400

(57) ABSTRACT

A vehicle comprising a front vehicle portion, a rear vehicle portion, and a pivot assembly connecting the front vehicle portion to the rear vehicle portion. The pivot assembly includes a horizontal axis pivot member and a vertical axis pivot member to allow the front vehicle portion to pivot about the rear vehicle portion about a horizontal axis and a vertical axis, respectively.

### CROSS REFERENCE TO RELATED APPLICATION

This claims the benefit of U.S. Provisional Application No. 61/625 962, filed Apr. 18, 2012, the disclosure of which is hereby incorporated by reference in its entirety.

### FIELD OF THE INVENTION

This invention relates generally to vehicles and, more particularly, to a joint for allowing a vehicle with a front portion and a rear portion to rotate relatively to each other.

### BACKGROUND OF THE INVENTION

Vehicles having a front vehicle portion and a rear vehicle portion can have a pivot between the front vehicle portion and the rear vehicle portion to allow the front vehicle portion to rotate relative to the rear vehicle portion to allow the vehicle to turn. In the past, because of the structural limitations of the vehicle, the front vehicle portion could only pivot relative to the rear vehicle portion by about 40° in either direction (for a total of 80°), thereby limiting a turn radius of the vehicle. A vehicle having a tighter turn radius is desired.

### SUMMARY OF THE INVENTION

An aspect of the present invention is to provide a vehicle comprising a front vehicle portion, a rear vehicle portion, and a pivot assembly connecting the front vehicle portion to the rear vehicle portion. The pivot assembly includes a horizontal axis pivot member and a vertical axis pivot member to allow the front vehicle portion to pivot about the rear vehicle portion about a horizontal axis and a vertical axis, respectively.

Another aspect of the present invention is to provide a vehicle comprising a front vehicle portion including an engine and driven wheels driven by the engine, a rear vehicle portion, and a pivot assembly connecting the front vehicle portion to the rear vehicle portion. The pivot assembly includes a passive horizontal axis pivot member and an active vertical axis pivot member to allow the front vehicle portion to pivot about the rear vehicle portion about a horizontal axis and a vertical axis, respectively. The vertical axis pivot member is hydraulically driven and activated to force the front vehicle portion to rotate relative to the rear vehicle portion about the vertical axis. The horizontal axis pivot member includes a first portion fixed to the vertical axis pivot member and a second portion fixed to the front vehicle portion.

### BRIEF DESCRIPTION OF DRAWINGS

FIG. 1 is a top view of vehicle of the present invention.

FIG. 2 is a partial perspective view of the vehicle of the present invention illustrating a joint between a front vehicle portion and a rear vehicle portion of the vehicle.

FIG. 3 is a partial cross-sectional view of the vehicle of the present invention illustrating the joint between the front vehicle portion and the rear vehicle portion of the vehicle.

FIG. 4 is a cross-sectional perspective view of a horizontal axis pivot assembly of the joint of the present invention.

FIG. 5 is a bottom partial view of the joint of the present invention with a rear vehicle portion joint connection assembly removed for clarity.

FIG. 6 is a perspective view of the joint of the present invention illustrating an optional tightening component of a horizontal axis pivot assembly of the joint.

FIG. 7 is an exploded perspective view of the joint of the present invention illustrating the optional tightening component of the horizontal axis pivot assembly of the joint.

FIG. 8 is an end perspective view of a rear of the front vehicle portion of the vehicle of the present invention with a rear plate removed to illustrate the optional tightening component of the horizontal axis pivot assembly of the joint.

### DETAILED DESCRIPTION OF PREFERRED EMBODIMENTS

For purposes of description herein, it is to be understood that the invention may assume various alternative orientations, except where expressly specified to the contrary. It is also to be understood that the specific devices and processes illustrated in the attached drawings, and described in the following specification, are simply exemplary embodiments of the inventive concepts defined herein. Hence, specific dimensions and other physical characteristics relating to the embodiments disclosed herein are not to be considered as limiting, unless expressly stated otherwise.

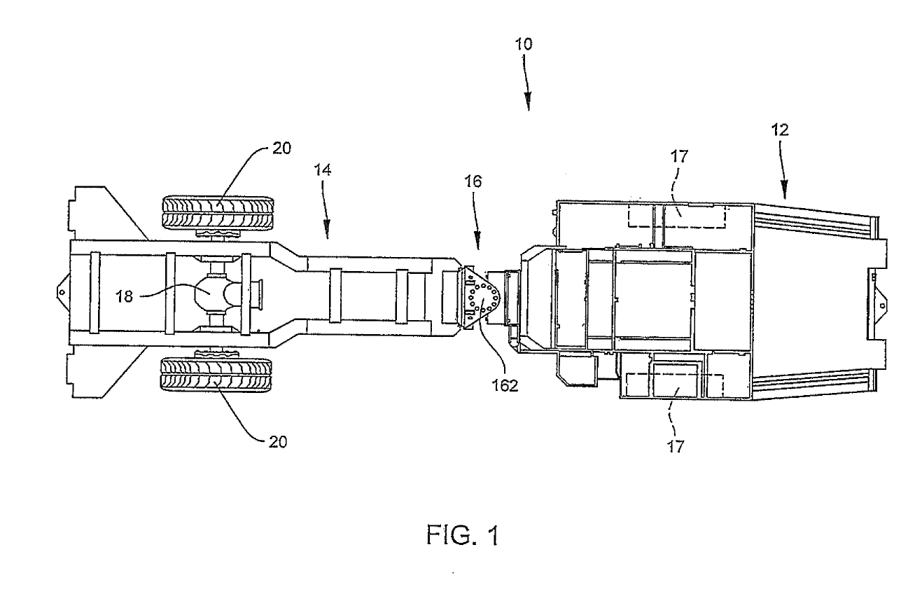

The reference number 10 (FIG. 1) generally designates a vehicle embodying the present invention. In the illustrated example, the vehicle 10 includes a front vehicle portion 12 and a rear vehicle portion 14. A powered joint 16 extends between the front vehicle portion 12 and the rear vehicle portion 14. The powered joint 16 allows the front vehicle portion 12 to pivot relative to the rear vehicle portion 14 about a vertical axis 162. It is contemplated that the powered joint 16 of the present invention can allow the front vehicle portion 12 to pivot relative to the rear vehicle portion 14 up to 105° in each direction (or a total range of 210° of relative motion), typically limited by the structure of the front vehicle portion 12 abutting the structure of the rear vehicle portion 14. In the illustrated example, the front vehicle portion 12 can pivot relative to the rear vehicle portion 14 up to 55° in each direction (or a total range of 115° of relative motion).

The illustrated front vehicle portion 12 propels the vehicle 10. The front vehicle portion 12 includes an engine for driving the vehicle 10 and at least one pair of driven wheels 17 for propelling the vehicle 10 (e.g., four wheel drive with two pairs of driven wheels 17). The pair of driven wheels 17 can be connected by a solid axle or cradle axle. Cradles axles are well known to those skilled in the art and any cradle axle can be used. For example, the front vehicle portion 12 can have the cradle axle discussed in U.S. Pat. No. 4,082,377 entitled AXLE CRADLE MOUNTING HAVING ELASTOMERIC SPHERICAL BUSHINGS, the entire contents of which are hereby incorporated herein by reference. The powered joint 16 of the present invention allows the vehicle 10 to employ a solid axle for the driven wheels 17 of the front vehicle portion 12. The rear vehicle portion 14 can comprise a trailer or any other structure and can include at least one axle 18 (solid or cradle) having a pair of wheels 20 connected to ends thereof.

In the illustrated example, the powered joint 16 can rotate the front vehicle portion 12 relative to the rear vehicle portion 14. The powered joint 16 includes a front vehicle portion joint connection assembly 22, a rear vehicle portion joint connection assembly 24 and a pivot actuator 26. The front vehicle portion joint connection assembly 22 is connected to the pivot actuator 26, which is in turn connected to the rear vehicle portion joint connection assembly 24 to connect the front vehicle portion 12 to the rear vehicle portion 14.

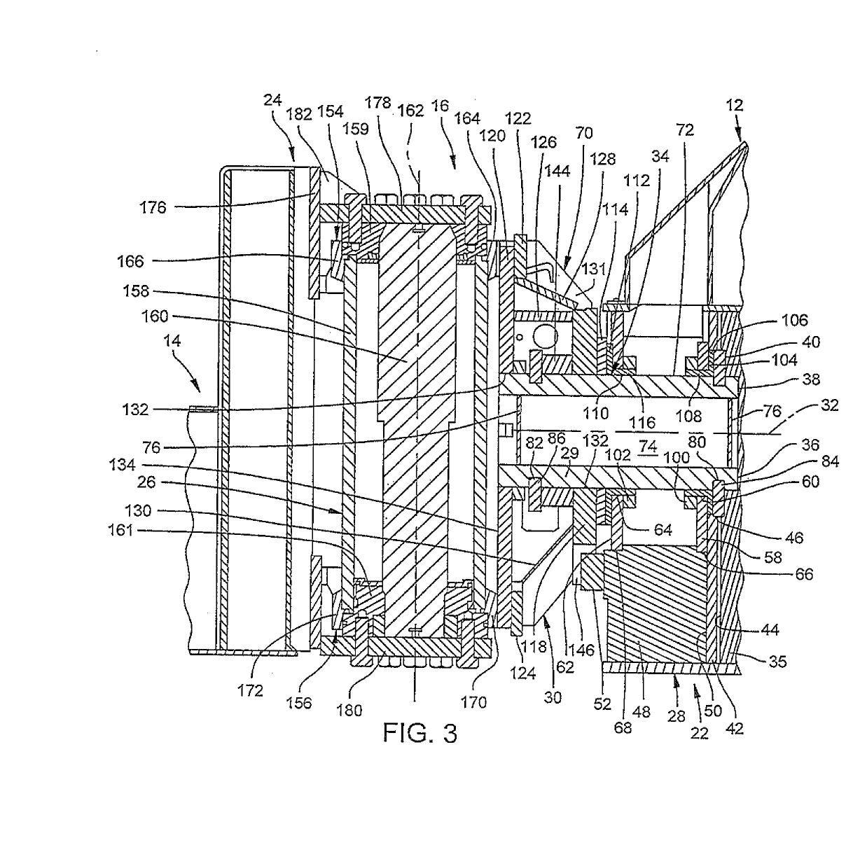

The illustrated front vehicle portion joint connection assembly 22 forms a rear section of the front vehicle portion 12 and is connected to the pivot actuator 26. The front vehicle portion joint connection assembly 22 includes a rear frame structure 28 of the front vehicle portion 12 and a horizontal axis pivot assembly 30. The horizontal axis pivot assembly 30 includes a horizontal axis pivot tube 29 received within the rear frame structure 28 of the front vehicle portion 12 and configured to rotate therein about a horizontal axis 32 (see FIG. 3).

In the illustrated example, the rear frame structure 28 (FIG. 3) receives the horizontal axis pivot assembly 30. The rear frame structure 28 includes a rear hole 34 receiving a portion of the horizontal axis pivot assembly 30 therein. As illustrated in FIG. 3, the rear frame structure 28 includes a front abutment wall 35 having a stepped counterbore 36 therein, with the stepped counterbore 36 being coaxial with the rear hole 34. The stepped counterbore 36 includes a small center counterbore 38 for receiving an end of the horizontal axis pivot tube 29 and a large outer counterbore 40 surrounding the small center counterbore 38. The rear frame structure 28 also includes a front support member 42 located adjacent to a rear face 44 of the front abutment wall 35, with the front support member 42 including an opening 46 therein for receiving the horizontal axis pivot tube 29 therethrough. A bottom support block 48 is located adjacent a lower rear face 50 of the front support member 42. The bottom support block 48 forms a rear end of the rear frame structure 28. As illustrated in FIG. 3, the bottom support block 48 includes a stop flange 52 extending rearwardly therefrom. As discussed in more detail below, the stop flange 52 limits rotational movement of the horizontal axis pivot assembly 30. A front support plate 58 having a front hole 60 therethrough and a rear support plate 62 having a rear hole 64 therethrough are located below the horizontal axis pivot tube 29. As illustrated in FIG. 3, the bottom support block 48 includes a front notch 66 receiving a bottom of the front support plate 58 and a rear notch 68 receiving a bottom of the rear support plate 62. It is contemplated that the bottom support block 48 could have the middle portion removed (or not included) and only comprise a front vertical plate below the front support plate 58 and a rear vertical plate below the rear support plate 62.

The illustrated rear hole 34 of the rear frame structure 28 is formed from (moving from the front to the rear) the stepped counterbore 36, the opening 46 in the front support member 42, the front hole 60 in the front support plate 58, and the rear hole 64 in the rear support plate 62. The horizontal axis pivot tube 29 of the horizontal axis pivot assembly 30 is received and rotates within the rear hole 34.

In the illustrated example, the horizontal axis pivot assembly 30 includes the horizontal axis pivot tube 29 and a connection assembly 70 connected to the horizontal axis pivot tube 29 and the pivot actuator 26. The horizontal axis pivot tube 29 allows the connection assembly 70, the pivot actuator 26 and the rear vehicle portion 14 to rotate relative to the front vehicle portion 12 about the horizontal axis 32. The horizontal axis pivot tube 29 has an outer surface 72 and an inner opening 74. A pair of parallel support plates 76 are located in the inner opening 74 of the horizontal axis pivot tube 29 and are connected to an inner surface 78 of the inner opening 74 of the horizontal axis pivot tube 29. The outer surface 72 of the horizontal axis pivot tube 29 includes a front circumferential channel 80 and a rear circumferential channel 82. The front circumferential channel 80 and the rear circumferential channel 82 are parallel. The front circumferential channel 80 receives a front lock collar 84 therein for locking the horizontal axis pivot tube 29 to the rear frame structure 28 and the rear circumferential channel 82 receives a rear lock collar 86 therein for locking the horizontal axis pivot tube 29 to the connection assembly 70.

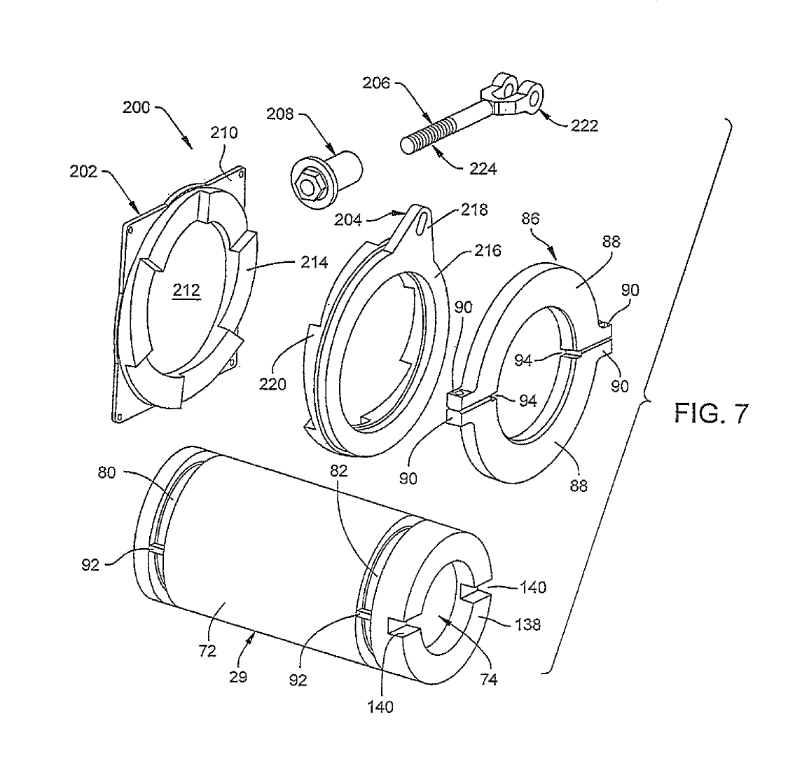

In the illustrated example, it is contemplated that the front lock collar 84 and the rear lock collar 86 can include identical configurations and can include a pair of collar halves 88 with end radially extending flanges 90 as illustrated in FIG. 7 (which shows the rear lock collar 86). Fasteners (not shown) extend through the end radially extending flanges 90 to connect the collar halves 88 together. As also illustrated in FIG. 7, the front circumferential channel 80 and the rear circumferential channel 82 can include at least one spanning stop 92 extending across the front circumferential channel 80 and the rear circumferential channel 82. The at least one spanning stop 92 is inserted into the front lock collar 84 and the rear lock collar 86 to prevent relative motion between the horizontal axis pivot tube 29 and the front lock collar 84 and the rear lock collar 86. As illustrated in FIG. 7, the spanning stop 92 can fit into a groove 94 located between the end radially extending flanges 90. However, it is contemplated that the horizontal axis pivot tube 29 and the front lock collar 84 and the rear lock collar 86 can be constructed to rotate relative to each other.

The illustrated horizontal axis pivot tube 29 is connected to the rear frame structure 28 by positioning the horizontal axis pivot tube 29 within the rear hole 34 of the rear frame structure 28. As illustrated in FIG. 3, when the horizontal axis pivot tube 29 is located within the rear hole 34 of the rear frame structure 28, a front end of the horizontal axis pivot tube 29 will be located within the small center counterbore 38 of the stepped counterbore 36 in the front abutment wall 35. The front lock collar 84 is partially located within the large outer counterbore 40 of the stepped counterbore 36 in the front abutment wall 35 and on the outer periphery of the opening 46 in the front support member 42. It is contemplated that the front lock collar 84 can be fixed in position relative to the front support member 42 and the front abutment wall 35, with the horizontal axis pivot tube 29 rotating relative to the front lock collar 84 or the front lock collar 84 can rotate within the stepped counterbore 36 in the front abutment wall 35 and the opening 46 in the front support member 42 (and can include stop tabs for limiting rotation of the front lock collar 84 and the horizontal axis pivot tube 29).

In the illustrated example, a front bearing ring 100 and a rear bearing ring 102 can hold a front wear ring pad 104 and a rear wear ring pad 110, respectively, in position to prevent wear on adjacent moving parts. The front wear ring pad 104 has an L-shaped cross-section and includes a vertical section 106 and a horizontal section 108. The vertical section 106 is located between the front support plate 58 and the front lock collar 84. The horizontal section 108 is located between the outer surface 72 of the horizontal axis pivot tube 29 and both an inner surface of the front bearing ring 100 and the outer periphery of the front hole 60 of the front support plate 58. Likewise, the rear wear ring pad 110 has an L-shaped cross-section and includes a vertical section 112 and a horizontal section 116. The vertical section 112 is located between the rear support plate 62 and a disc-shaped spacer plate 114 located between the connection assembly 70 and the rear frame structure 28. The horizontal section 116 is located between the outer surface 72 of the horizontal axis pivot tube 29 and both an inner surface of the rear bearing ring 102 and the outer periphery of the rear hole 64 of the rear support plate 62. The front wear ring pad 104 and the rear wear ring pad 110 reduce wear of the horizontal axis pivot tube 29 and adjacent parts as the horizontal axis pivot tube 29 rotates.

The illustrated connection assembly 70 is fixedly connected to the horizontal axis pivot tube 29 and rotates therewith. The connection assembly 70 can comprise any solid construction solidly connected to the horizontal axis pivot tube 29 and the pivot actuator 26. In the illustrated embodiment, the connection assembly 70 includes a plurality of plates welded together. Namely, the connection assembly 70 includes a front vertical plate 118, a rear vertical plate 120, a top vertical plate 122 connected to a front top face of the rear vertical plate 120, a bottom vertical plate 124 connected to a front bottom face of the rear vertical plate 120, a top horizontal plate 126 extended between the front vertical plate 118 and the rear vertical plate 120, a top angled plate 128 extended from a top of the front vertical plate 118 upward toward an intersection with the rear vertical plate 120 at a bottom edge of the top vertical plate 122, and a bottom angled plate 130 extended from a top of the front vertical plate 118 downward toward an intersection with the rear vertical plate 120 at a top edge of the bottom vertical plate 124. The connection assembly 70 also includes a pair of side plates 131 covering sides of the front vertical plate 118, the rear vertical plate 120, the top vertical plate 122, the bottom vertical plate 124, the top horizontal plate 126, the top angled plate 128, and the bottom angled plate 130.

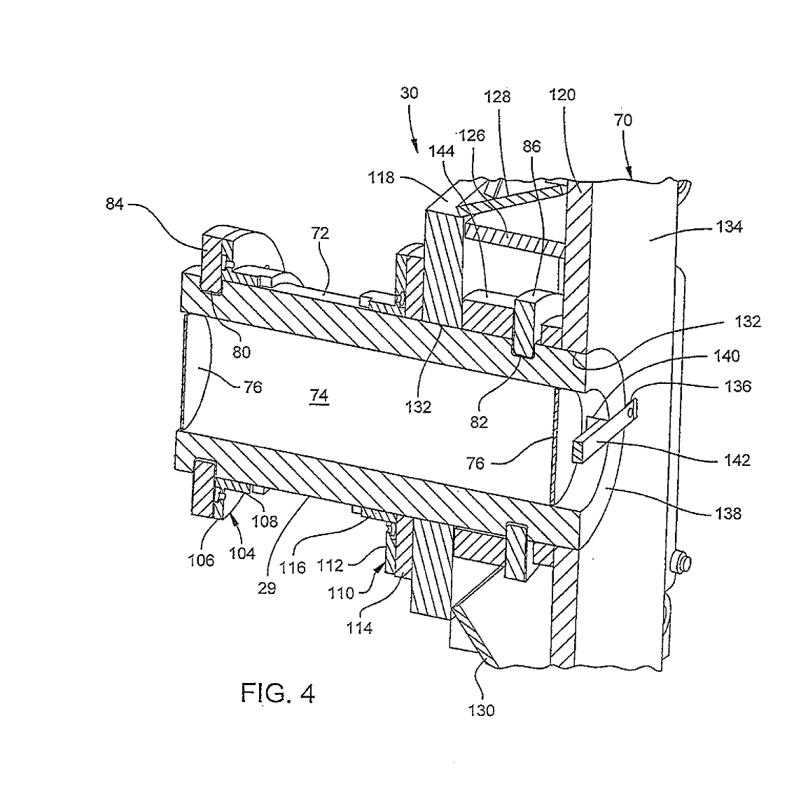

In the illustrated example, the horizontal axis pivot tube 29 extends through the connection assembly 70. As illustrated in FIGS. 3 and 4, the front vertical plate 118 and the rear vertical plate 120 have aligned circular openings 132. The horizontal axis pivot tube 29 extends fully through the front vertical plate 118 and through the rear vertical plate 120 to a position flush with a rear face 134 of the rear vertical plate 120. The rear face 134 of the rear vertical plate 120 has a pair of radially extending holding rod grooves 136 that are radially aligned with one another on opposite sides of the circular opening 132 and open in a rear direction. A rear circular edge 138 of the horizontal axis pivot tube 29 also includes a pair of radially extending holding rod grooves 140 that are radially aligned with one another on opposite sides of the inner opening 74 of the horizontal axis pivot tube 29.

The illustrated connection assembly 70 connects with and rotates with the horizontal axis pivot tube 29. As illustrated in FIG. 4, a holding rod 142 is inserted into the pair of radially extending holding rod grooves 136 in the rear face 134 of the rear vertical plate 120 and into the pair of radially extending holding rod grooves 140 in the rear circular edge 138 of the horizontal axis pivot tube 29. Moreover, fasteners are inserted through ends of the holding rod 142 and into the rear vertical plate 120 of the connection assembly 70 to rotatably connect the horizontal axis pivot tube 29 to the connection assembly 70 such that the horizontal axis pivot tube 29 and the connection assembly 70 rotate as an integral unit. The horizontal axis pivot tube 29 is maintained in position axially by compressing a fixing ring 144 between the rear lock collar 86 and the front vertical plate 118 of the connection assembly 70 within the connection assembly 70. The fixing ring 144 can include a single solid piece or a plurality of shim inserted between the rear lock collar 86 and the front vertical plate 118 of the connection assembly 70. As stated above, the disc-shaped spacer plate 114 is compressed between the front vertical plate 118 of the connection assembly 70 and the rear wear ring pad 110 to further fix the horizontal axis pivot tube 29 in an axial position. The disc-shaped spacer plate 114 can be free to rotate or fixedly connected to the front vertical plate 118 of the connection assembly 70.

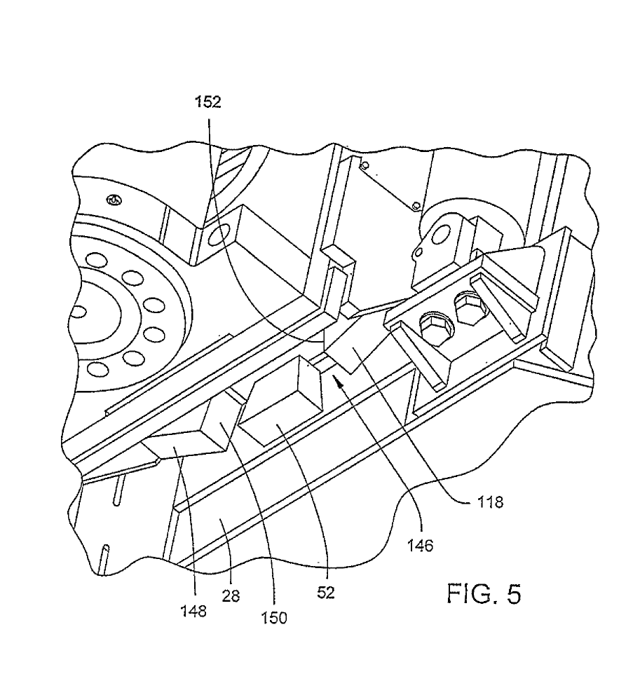

The illustrated horizontal axis pivot assembly 30 is configured to rotate about the horizontal axis 32. However, the stop flange 52 of the bottom support block 48 of the rear frame structure 28 limits the rotational movement of the horizontal axis pivot assembly 30. As illustrated in FIG. 5, the front vertical plate 118 of the connection assembly 70 includes a centrally located notch 146 in a bottom edge 148 thereof. The centrally located notch 146 includes a first abutment face 150 and an opposite second abutment face 152. As the horizontal axis pivot assembly 30 rotates in a first direction, the first abutment face 150 of the centrally located notch 146 in the front vertical plate 118 of the connection assembly 70 will abut the stop flange 52 to prevent further rotation of the horizontal axis pivot assembly 30 in the first direction. Likewise, as the horizontal axis pivot assembly 30 rotates in a second direction, the second abutment face 152 of the centrally located notch 146 in the front vertical plate 118 of the connection assembly 70 will abut the stop flange 52 to prevent further rotation of the horizontal axis pivot assembly 30 in the second direction. Accordingly, the stop flange 52 will limit rotation of the horizontal axis pivot assembly 30 between the distance of an arc between the first abutment face 150 and the second abutment face 152 of the notch 146. It is contemplated that the horizontal axis pivot assembly 30 can be limited to any degree of rotation depending on the use of the vehicle 10. For example, the horizontal axis pivot assembly 30 can be limited to 20° of rotation (10° in each direction).

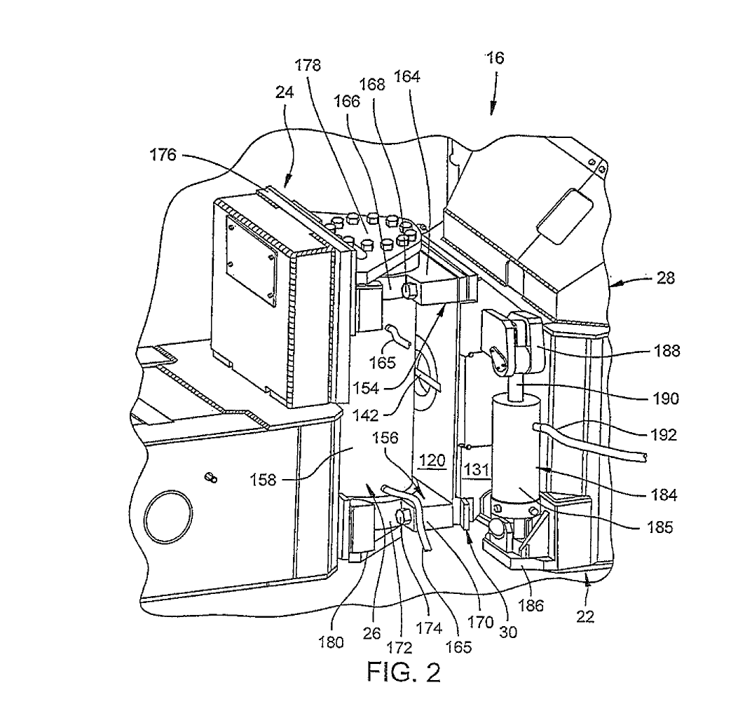

In the illustrated example, the horizontal axis pivot assembly 30 rotates about the horizontal axis 32 with the pivot actuator 26. The pivot actuator 26 includes an external cylinder 158 and an internal cylinder 160 (or similar structure) that rotates relative to the external cylinder 158. The pivot actuator 26 also includes a top cap 159 connected to a top of the internal cylinder 160 and a bottom cap 161 connected to a bottom of the internal cylinder 160. The top cap 159 and the bottom cap 161 have substantially the same diameter as the external cylinder 158 to cover ends of the same {with a seal between the caps 159, 161 and the external cylinder 158 to allow the caps 159, 161 to rotate with the internal cylinder 160 relative to the external cylinder 158). It is contemplated that the pivot actuator 26 could be a passive joint if the vehicle 10 includes at least one set of turnable wheels (for the front vehicle portion 12 and/or the rear vehicle portion 14). If the vehicle does not include turnable wheels (and even if it does), the pivot actuator 26 can be powered to actively rotate the front vehicle portion 12 relative to the rear vehicle portion 14 about the vertical axis 162 extending through a center of the pivot actuator 26. The pivot actuator 26 can be the actuator disclosed in U.S. Pat. No. 5,447,095 entitled “ACTUATOR WITH RING GEAR AND METHOD OF MANUFACTURING SAME,” the entire contents of which are hereby incorporated herein by reference. The pivot actuator 26 can also be an L30 helical, hydraulic actuator as sold by Helac Corporation® of Enumclaw, Wash. The pivot actuator 26 can be powered hydraulically or by other means. As illustrated in FIG. 2, the external cylinder 158 has hydraulic lines 165 connected thereto for supplying the pivot actuator 26 with hydraulic fluid under pressure (from a source of pressurized fluid on the vehicle 10) to power the pivot actuator 26.

The illustrated horizontal axis pivot assembly 30 is fixedly connected to and rotates about the horizontal axis 32 with the pivot actuator 26. The rear vertical plate 120 of the connection assembly 70 includes a top connection collar 154 and a bottom connection collar 156 extending rearwardly therefrom. The top connection collar 154 includes a base plate 164 and a ring collar portion 166. The base plate 164 of the top connection collar 154 is fixed to the rear vertical plate 120 at a top of the rear face thereof (by, e.g., fasteners 168) and the ring collar portion 166 surrounds an exterior periphery of a top circumferential surface of the external cylinder 158 of the pivot actuator 26. The ring collar portion 166 of the top connection collar 154 is fixed to the external cylinder 158 of the pivot actuator 26 by any means (e.g., fasteners). Similarly, the bottom connection collar 156 includes a base plate 170 and a ring collar portion 172. The base plate 170 of the bottom connection collar 156 is fixed to the rear vertical plate 120 at a bottom of the rear face thereof (by, e.g., fasteners 174) and the ring collar portion 172 surrounds an exterior periphery of a bottom circumferential surface of the external cylinder 158 of the pivot actuator 26. The ring collar portion 172 of the bottom connection collar 156 is fixed to the external cylinder 158 of the pivot actuator 26 by any means (e.g., fasteners). Accordingly, the rear vertical plate 120 of the connection assembly 70 is fixedly connected to the external cylinder 158 of the pivot actuator 26 to pivot with the external cylinder 158 about the vertical axis 162.

In the illustrated example, the rear vehicle portion 14 of the vehicle 10 is also connected to the pivot actuator 26 to be able to pivot about the vertical axis 162. The powered joint 16 includes the rear vehicle portion joint connection assembly 24 connected to pivot actuator 26. The rear vehicle portion joint connection assembly 24 includes a panel 176 connected to a front of the rear vehicle portion 14. The panel 176 includes an arched top connection panel 178 and a parallel arched bottom connection panel 180 extending forwardly therefrom in a cantilever fashion. The rear vehicle portion joint connection assembly 24 is fixedly connected to the pivot actuator 26 by fastening the arched top connection panel 178 to the top cap 159 of the pivot actuator 26 and the arched bottom connection panel 180 to the bottom cap 161 of the pivot actuator 26. Therefore, the rear vehicle portion joint connection assembly 24 and the rear vehicle portion 14 will rotate about the vertical axis 162 with the top cap 159, the bottom cap 161 and the internal cylinder 160 of the pivot actuator 26. It is contemplated that the rear vehicle portion joint connection assembly 24 could include struts 182 spanning between the panel 176 and either or both of the arched top connection panel 178 and the arched bottom connection panel 180 to solidify the connection between the panel 176 and the arched top connection panel 178 and/or the arched bottom connection panel 180.

It is contemplated that the illustrated connection assembly 70 and horizontal axis pivot tube 29 could be locked in position to prevent rotation relative to the rear frame structure 28. As illustrated in FIG. 2, a linear actuator 184 is connected to the connection assembly 70 and the rear frame structure 28 to prevent rotation of the connection structure 70 relative to the rear frame structure 28 about the horizontal axis 32. In the illustrated example, the bottom support block 48 of the rear frame structure 28 can include a support leg 186 extending rearwardly from a bottom side portion thereof. The support leg 186 includes a pin (not shown) substantially parallel to the horizontal axis 32, with a bottom housing of the linear actuator 184 having a hole (not shown) in a bottom thereof receiving the pin of the support leg 186 to pivotally connect a base housing 185 of the linear actuator 184 to the support leg 186. The connection assembly 70 includes a pair of parallel arms 188 extending sidewardly from one of the side plates 131 of the connection assembly 70. A pin (not shown) substantially parallel to the horizontal axis 32 extends between the parallel arms 188 and an opening (not shown) in an extension arm 190 of the linear actuator 184 receives the pin of the extension arm 190 to pivotally connect the extension arm 190 of the linear actuator 184 to the connection assembly 70. The base housing 185 of the linear actuator 184 can have a tube 192 connected thereto for supplying the linear actuator 184 with a fluid (hydraulic or pneumatic) to selectively lock the extension arm 190 in a selected position out of the base housing 185 of the linear actuator 184 to prevent the connection assembly 70 from pivoting about the horizontal axis 32. The linear actuator 184 can be activated to prevent rotation of the rear vehicle portion 14 relative to the front vehicle portion 12 about the horizontal axis 32. The linear actuator 184 can be actuated to help the vehicle 10 prevent rotation of the rear vehicle portion 14 relative to the rear vehicle portion 12 when stabilizer arms (not shown) on the front vehicle portion 12 are lowered to stabilize the front vehicle portion 12, which can sometimes cause the front vehicle portion 12 to lift off of the ground. It is also contemplated that the linear actuator 184 can include a dampening system (e.g., shock absorber) or could be substituted for a dampening system. It is also contemplated that the linear actuator 184 could be actuated to positively rotate the rear vehicle portion 14 relative to the front vehicle portion 12.

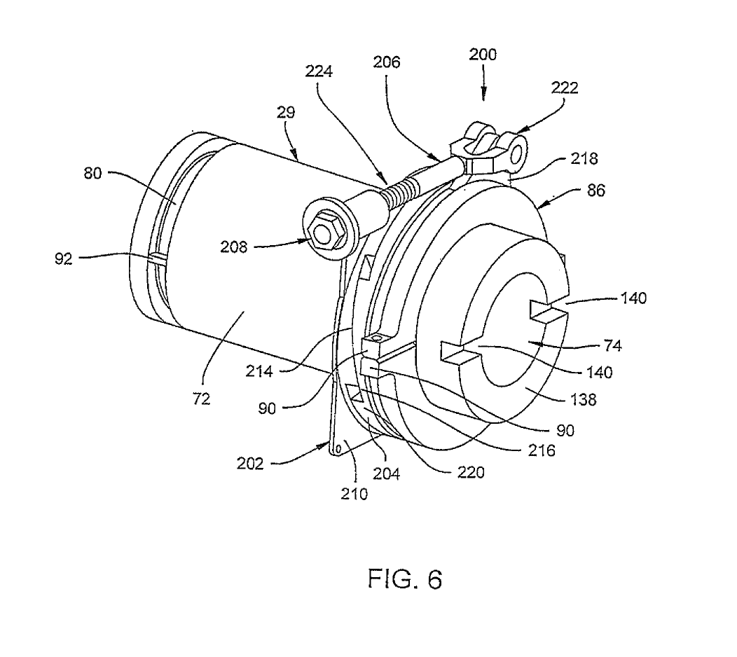

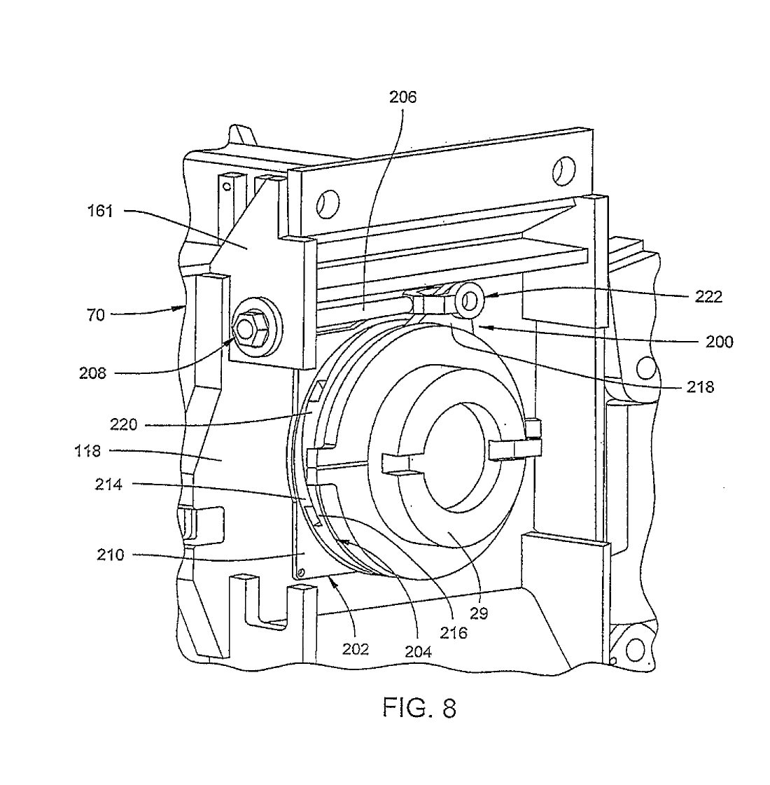

FIGS. 6-8 illustrate an alternative for the engagement between the connection assembly 70 and the horizontal axis pivot tube 29 by substituting a tightening mechanism 200 for the fixing ring 144 described above. The tightening mechanism 200 allows a user of the vehicle to adjust a distance between the rear lock collar 86 and the front vertical plate 118 of the connection assembly 70 within the connection assembly 70 to fix the horizontal axis pivot assembly 30 within the front vehicle portion joint connection assembly 22 and potentially increase a friction resistance force between disc-shaped spacer plate 114 and the front vertical plate 118 of the connection assembly 70 and/or the rear wear ring pad 110. The tightening mechanism 200 can also be used to adjust the distance between the rear lock collar 86 and the front vertical plate 118 of the connection assembly 70 within the connection assembly 70 to account for wear reducing the thickness of the front wear ring pad 108 and/or the rear wear ring pad 110.

The illustrated tightening mechanism 200 includes a fixed front adjustment plate 202, a variable rear adjustment plate 204, a threaded connector arm 206 and an adjustor nut 208. The fixed front adjustment plate 202 includes a panel 210 having a substantially rectangular outer periphery and a central opening 212 for receiving the horizontal axis pivot tube 29 therethrough. A rear face of the panel 210 of the fixed front adjustment plate 202 includes a plurality of rearward facing ramps 214 arranged in a circle outside of the central opening 212 therein. The variable rear adjustment plate 204 includes an adjustment ring 216 having the horizontal axis pivot tube 29 extending therethrough and including a radially extending adjustment tab 218. A plurality of forward facing ramps 220 extend forwardly from the adjustment ring 216 of the variable rear adjustment plate 204. The threaded connector arm 206 includes a first end 222 connected to the radially extending adjustment tab 218 of the variable rear adjustment plate 204 and a second threaded end 224 inserted into the adjustor nut 208. In the illustrated example, the fixed front adjustment plate 202 is fixed in position within the connection assembly 70 against the front vertical plate 118 thereof. The second threaded end 224 of the threaded connector arm 206 extends through an opening in one of the side plates 131 of the connection assembly 70.

In the illustrated example, the tightening mechanism 200 is used by rotating the adjustor nut 208, thereby moving the second threaded end 224 into or out of the adjustor nut 208 to thereby move the threaded connector arm 206 toward or away from the side plate 131 of the connector assembly 70. As the threaded connector arm 206 is moved toward or away from the side plate 131, the first threaded end 222 of the threaded connector arm 206 pulls or pushes on the radially extending adjustment tab 218 of the variable rear adjustment plate 204, thereby causing the variable rear adjustment plate 204 to rotate about the horizontal axis pivot tube 29. As the variable rear adjustment plate 204 is rotated, the plurality of forward facing ramps 220 thereon ride up or down on the plurality of rearward facing ramps 214 of the panel 210 of the fixed front adjustment plate 202, thereby pushing the variable rear adjustment plate 204 toward or away from the fixed front adjustment plate 202 and thereby adjusting a distance between the rear lock collar 86 and the front vertical plate 118 of the connection assembly 70 within the connection assembly 70.

It is to be understood that variations and modifications can be made on the aforementioned structure without departing from the concepts of the present invention.

We claim:

1. A vehicle comprising:
a front vehicle portion;
a rear vehicle portion; and
a pivot assembly connecting the front vehicle portion to the rear vehicle portion, the pivot assembly including a horizontal axis pivot member and a vertical axis pivot member to allow the front vehicle portion to pivot about the rear vehicle portion about a horizontal axis and a vertical axis, respectively.

2. The vehicle of claim 1, wherein:
the horizontal axis pivot member is passive; and
the vertical axis pivot member is driven and is activated to force the front vehicle portion to rotate relative to the rear vehicle portion about the vertical axis.

3. The vehicle of claim 2, wherein:
the vertical axis pivot member is hydraulically driven.

4. The vehicle of claim 1, wherein:
the pivot assembly is configured to rotate 120° about the vertical axis.

5. The vehicle of claim 1, wherein:
the front vehicle portion has an engine and driven wheels driven by the engine.

6. The vehicle of claim 5, wherein:
the driven wheels are connected by a solid axle.

7. The vehicle of claim 1, wherein:
the horizontal axis pivot member including a first portion fixed to the vertical axis pivot member and a second portion fixed to the front vehicle portion.

8. The vehicle of claim 7, wherein:
the front vehicle portion has a projecting stop;
the first portion of the horizontal axis pivot member includes a slot between a pair of abutment walls; and
the projecting stop abuts one of the pair of abutment walls to limit rotation of the first portion of the horizontal axis pivot member and the vertical axis pivot member about the horizontal axis.

9. The vehicle of claim 8, wherein:
the projecting stop limits rotation of the first portion of the horizontal axis pivot member relative to the second portion of the horizontal axis pivot member to 20°.

10. The vehicle of claim 7, further including:
a lock device connected to the front vehicle portion and the first portion of the horizontal axis pivot member;
the lock device being configured to lock a relative position between the first portion of the horizontal axis pivot member and the second portion of the horizontal axis pivot member.

11. The vehicle of claim 10, wherein:
the lock device comprises a linear actuator.

12. A vehicle comprising:
a front vehicle portion including an engine and driven wheels driven by the engine;
a rear vehicle portion; and
a pivot assembly connecting the front vehicle portion to the rear vehicle portion, the pivot assembly including a passive horizontal axis pivot member and an active vertical axis pivot member to allow the front vehicle portion to pivot about the rear vehicle portion about a horizontal axis and a vertical axis, respectively;
the active vertical axis pivot member being hydraulically driven and activated to force the front vehicle portion to rotate relative to the rear vehicle portion about the vertical axis;
the passive horizontal axis pivot member including a first portion fixed to the active vertical axis pivot member and a second portion fixed to the front vehicle portion.

13. The vehicle of claim 12, further including:
a lock device connected to the front vehicle portion and the first portion of the passive horizontal axis pivot member;
the lock device being configured to lock a relative position between the first portion of the passive horizontal axis pivot member and the second portion of the passive horizontal axis pivot member.

14. The vehicle of claim 13, wherein:
the lock device comprises a linear actuator.

15. The vehicle of claim 12, wherein:
the first portion of the passive horizontal axis pivot member includes a plurality of radially extending lock plates received with the second portion of the passive horizontal axis pivot member for keeping the first portion of the passive horizontal axis pivot member within the second portion of the passive horizontal axis pivot member.
